(19) United States
(12) Patent Application Publication
(10) Pub. No.: US 2002/0188959 A1
(43) Pub. Date: Dec. 12, 2002

(54) Parallel and synchronized display of augmented multimedia information

(75) Inventor: Tony E. Piotrowski, Wayne, NJ (US)

Correspondence Address: Jack E. Haken, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/878,978

(22) Filed: Jun. 12, 2001

(51) Int. Cl. H04N 7/173; H04N 7/16; H04N 7/00; H04N 11/00; H04H 9/00

(52) U.S. Cl. 725/112; 725/20; 348/464

(57) ABSTRACT

A system and method are disclosed that allow viewers of video/TV programs to automatically, or by request, receive synchronized supplemental multimedia information related to the video/TV programs. The supplemental multimedia information is received as an. Internet document, e.g., using Synchronized Multimedia Integration Language (SMIL). Synchronizing information is received/extracted from the video/TV program. The synchronizing information may be in the form of keyframes, image triggers extracted using image recognition technology, time codes or Closed Captioning (CC) and Extended Data Services (EDS) codes. The video/TV program and the supplemental multimedia information are then displayed as a virtual web page.

### FIELD OF THE INVENTION

The present invention pertains generally to the field of video communications, and in particular, the invention relates to a system and method for allowing users to automatically, or by request, receive synchronized supplemental multimedia information related to the video/TV programs

### BACKGROUND OF THE INVENTION

Due to various reasons including time constraints, a typical Video/TV program must flow in a relatively quick and fluid manner. In many situations, this means writers must limit the amount of detail and only summarize the actions of a character to keep the action flowing smoothly. This conventional format also limits possible viewer interaction with the video/TV program. While this allows such video/TV programs to fit conveniently within a half-hour or multiple thereof time-slot, it limits the amount of information available that can be provided to the viewers of such video/TV programs.

A wealth of supplemental information material is (e.g., from story-line changes and revisions) and could be created that may be used to supplement typical video/TV programs. For example, additional scenes or additional details related to the video/TV program could be provided. Also, simultaneous viewer interaction could be added to broadcast programs.

Some conventional systems have been developed using community antenna television facilities (CATV) that allow subscribers to interactively request still-television video frames with an accompanying audio message. However, the TV video and accompanying audio message provided by these systems are not related to, or synchronized to, broadcast TV programs.

Attempts have also been made to link Video/TV programs to information on the Internet. For example, some live sports programs allow viewers to log-on to a related website to interact/obtain more information about the sports program. However, the additional information is not actually synchronized to the sports program. These systems require constant manual intervention and programming by the sports program providers to update and provide the additional information on the website.

Accordingly, there is a need for a system that solves the above described problems. In particular, a method and system that allows program viewers to select/receive synchronized supplemental information related to video/TV programs.

### BRIEF SUMMARY OF THE INVENTION

It is an object of the present invention to address the limitations of the conventional display systems discussed above.

One aspect of the present invention is directed to a system for allowing users to automatically, or by request, receive synchronized supplemental multimedia information related to the video/TV programs using Synchronized Multimedia Integration Language (SMIL).

In one embodiment, codes transmitted as part of the Closed Captioning (CC) or Extended Data Services (EDS) system may be used to initiate the supplemental multimedia information.

In another embodiment, keyframes or extracted data using image recognition technology may be used to synchronize the supplemental multimedia information to the video/TV program.

One preferred embodiment of the invention relates to a method for providing supplemental multimedia information to a video program. The method includes the steps of displaying the video program, receiving synchronizing information from the video program and receiving the supplemental multimedia information in accordance with the synchronizing information formatted as an Internet document. The supplemental multimedia information is then displayed as a virtual web page.

Another embodiment of the invention relates to a display apparatus including a television receiver arranged to receive a television program signal and an Internet enabled device arranged to received supplemental information comprising an Internet document. The apparatus also includes means for synchronizing the supplemental information to the video program and means for displaying the television program signal and the supplemental information as a virtual web page.

These and other embodiments and aspects of the present invention are exemplified in the following detailed disclosure.

### BRIEF DESCRIPTION OF DRAWINGS

The features and advantages of the present invention can be understood by reference to the detailed description of the preferred embodiments set forth below taken with the drawings, in which:

FIG. 1 is a communication system in accordance with a preferred embodiment of the present invention.

FIG. 2 is an illustration of a display in accordance with one embodiment of the invention.

FIG. 3. is a block diagram of an exemplary computer system capable of supporting the system of FIG. 1.

FIG. 4 is a block diagram showing the architecture of the computer system of FIG. 3.

### DESCRIPTION OF THE PREFERRED EMBODIMENTS

One preferred embodiment of the present invention relates to a system for allowing users to automatically, or by request, receive synchronized supplemental multimedia information related to the video/TV programs using Synchronized Multimedia Integration Language (SMIL) and synchronizing information received/extracted from the video/TV program (e.g., keyframes or extracted data using image recognition technology).

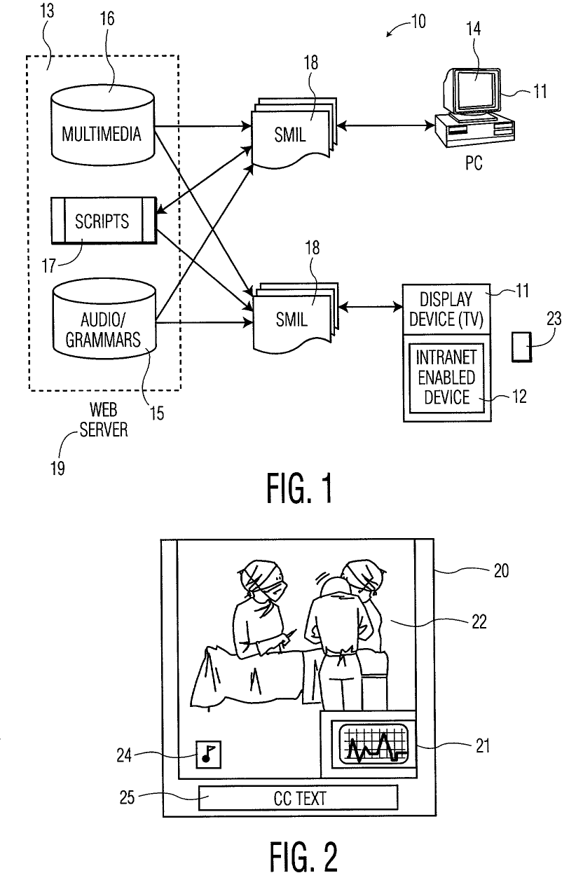

Referring to FIG. 1, a system 10 includes a display device 11 such as a television system or personal computer with a DVD drive. The display device 11 is coupled to, or integrated with (e.g., WebTV), an internet enabled device 12. The system 10 enables video/multimedia program viewers to automatically, or by request, receive synchronized supplemental multimedia information 13, through the internet enabled device 12, related to a particular video/multimedia program 14 being viewed. The supplemental multimedia information 13 may be displayed simultaneously with the video/multimedia program 14 via the display device, e.g., a pop-up window.

The internet enabled device 12 can communicate to one or more of remote devices over a network. The network may be a global computer communications network such as the Internet, a wide area network, a metropolitan area network, a local area network, a cable network, a satellite network or a telephone network, as well as portions or combinations of these and other types of networks.

The network is accessed by the internet enabled device 12 through wired connections, wireless connections or combinations thereof, using well-known conventional communication protocols such as the Internet Protocol (IP). An advantage of this embodiment is that a wide variety of system architectures can be used to implement the system of FIG. 1, e.g., client/server architectures can be used.

It is understood that the video/multimedia program 14 may be one of many television programs 19 that are broadcast or transmitted to the public. The video program may be a sitcom, a sports program, a news program, a movie, a commercial, a soap opera, a documentary, a cartoon, a how-to show, etc. The television program 19 is received and displayed by conventional electronic equipment. The electronic equipment may receive the television program 19 through an antenna adapted to receive TV signals from a TV broadcast station, from a satellite transponder, a trunk cable from a CATV (i.e. cable TV) system, or from any other suitable transmission means.

The supplemental multimedia information 13 may include additional audio sound tracks 15 and visual information 16 for the video/multimedia program 14. This information may include (1) additional information about the characters, story-lines and background information related to the video/multimedia program, (2) close-ups of specific items within the program, (3) alternative camera angles, (4) alternative scenes and dialogue for characters, (5) supplemental information related to commercials or advertisements and (6) interactive prompts/sequences for the viewer to select.

The supplemental multimedia information 13 is edited and synchronized to the action and events of the video/multimedia program 14. This ensures that the supplemental multimedia information 13 is available to the viewer at the proper times throughout the video/multimedia program 14. Keyframes from the video/multimedia program 14 may be used to ensure proper synchronization. The supplemental multimedia information 13 can also be synchronized using time codes within the video/TV program 14.

In addition, image recognition may be used for this purpose as well. For example, image recognition technology may be used to monitor the data stream of the video/multimedia program. When a specific object (e.g., a face or can of soda) is identified, additional information may be displayed related to that object. Preferably, image triggers 24 (see FIG. 2) are inserted/embedded in the video/multimedia program. These image triggers 24 may be icons such as musical note or camera that indicate that the supplemental multimedia information 13 is available. The image triggers 24 may be visible or not visible. The visible image triggers 24 may also be used to prompt the viewer to request the supplemental multimedia information.

In another embodiment, codes transmitted as part of the Closed Captioning (CC) or Extended Data Services (EDS) system may be used to initiate the supplemental multimedia information 13. For example, as shown in FIG. 2, the codes can trigger a message 25 as part of the CC system. Such code can be added to the known codes of the CC or EDS system using a similar format. The CC and EDS systems are well known are not described in detail herein.

It is also understood that the supplemental multimedia information 13 is accessible/usable even if the video/multimedia program 14 is recorded on a recorded medium and played-back by the viewer.

As shown in FIG. 1, the supplemental multimedia information 13 may be located a remote site 19, e.g., a web server. The remote site 19 may include a data storage device that stores the multimedia and audio information related to the multimedia program 14. In addition, the data storage device includes scripts or executable programs that are used to provide access to and synchronize information for the multimedia program 14. While FIG. 1 depicts separate databases, a single database that incorporates the functions the databases mentioned above can also be used. Additional databases may be added as needed to store a variety of other information that may be required for other purposes. The data storage may be any suitable storage medium such as audio/video cassettes, digital audio tapes (DAT), laser discs, DVDs, and the like.

As discussed above, the supplemental multimedia information (e.g., via web pages) may be accessed from the web server 19. Web pages are typically written using a programming language called Hypertext Markup Language (HTML). Other hypertext programming languages may also be used to create the hypertext documents such as Dynamic HTML (DHTML), eXtensible Markup Language (XML), Synchronized Multimedia Integration Language (SMIL). Generally, HTML commands, i.e., tags, provide functions for defining the layout/format of the web page, embedding sound and images in the web page and adding links (i.e., hyperlinks) to other web pages or web sites. These links allow the user to select a word, phrase or image (referred to as a “hypertext anchor”) to go to, or receive information from, a web site which may be located on a remote server.

Preferably, the transfer and display of the supplemental multimedia information 13 is facilitated using SMIL. SMIL is an XML-based language that allows developers to mix media presentations to be presented and synchronized with each other. It provides a tool set for building time-based, streaming multimedia presentations that can combine audio, video, images and text. In this case, the display device 11 creates a screen display that simulates a web page display (i.e., a virtual web page displaying the multimedia program 14). The multimedia program 14 is displayed in a primary viewing window 20 while the supplemental multimedia information 13 may be displayed in a pop-up window 21 (see FIG. 2).

Using SMIL, media components are named for text, images, audio and video with URLs and to schedule their presentation either in parallel or in sequence. A SMIL presentation may have the following characteristics:

The presentation is composed from several components that are accessible via URL's, e.g. files stored on a Web server.

The components have different media types, such as audio, video, image or text. The begin and end times of different components are specified relative to events in other media components.

Familiar looking control buttons such as stop, fast-forward and rewind allow the user to interrupt the presentation and to move forwards or backwards to another point in the presentation.

Additional functions are “random access”, i.e. the presentation can be started anywhere, and “slow motion”, i.e. the presentation is played slower than at its original speed.

The user can follow hyperlinks embedded in the presentation.

In a preferred embodiment, SMIL provides the framework for facilitating the communication of the supplemental multimedia information 13. The synchronization codes (e.g., the Keyframes, image identifications or time codes) are received or extracted from the video/multimedia program 14 (as well as from the supplemental multimedia information 13 which may act as a trigger for another element) and act as triggers to initiate access/display of the supplemental multimedia information 13. These synchronization codes are processed by the SMIL server via scripts 17 to provide the necessary response via a SMIL document 18. The SMIL document is formatted to be transmitted as an Internet document.

One embodiment of the invention relates to watching TV. A viewer may be watching a typical TV program, e.g., a medical drama program. During the show, the viewer may receive additional information related to the program, e.g., see the doctor's patent report while he is writing it. The viewer may also follow a secondary character up to surgery rather than stay with the main story-line of the program (which has turned in a different direction). The view may also receive additional information related to characters or products in commercials. The viewer may have the option of making the supplemental multimedia information 13 appear in the primary viewing window 20 or in the pop-up window 21. The size and location of the viewing windows may also vary as desired by the viewer.

The supplemental multimedia information 13 may automatically “pop-up” in a small picture-in-picture type window 21 as appropriate. The supplemental multimedia information 13 may also be requested by the viewer, i.e., a request to always follow a specific character 22 or only receive additional information when prompted by the viewer. An initiate set-up or preference menu may be accessed by the viewer before and/or during the multimedia program 14 to set these preferences. This may be done via conventional On Screen Display (OSD) technology in televisions.

In another embodiment, the supplemental multimedia information may relate to a live sports program. In this case, the supplemental multimedia information allows the viewer to interact with the sport program. The viewer may receive additional athlete information and/or allow the viewer to play along with the sports program (e.g., guess the next play type game). The viewer may enter data via a remote control 23 or an input device such as a keyboard or mouse.

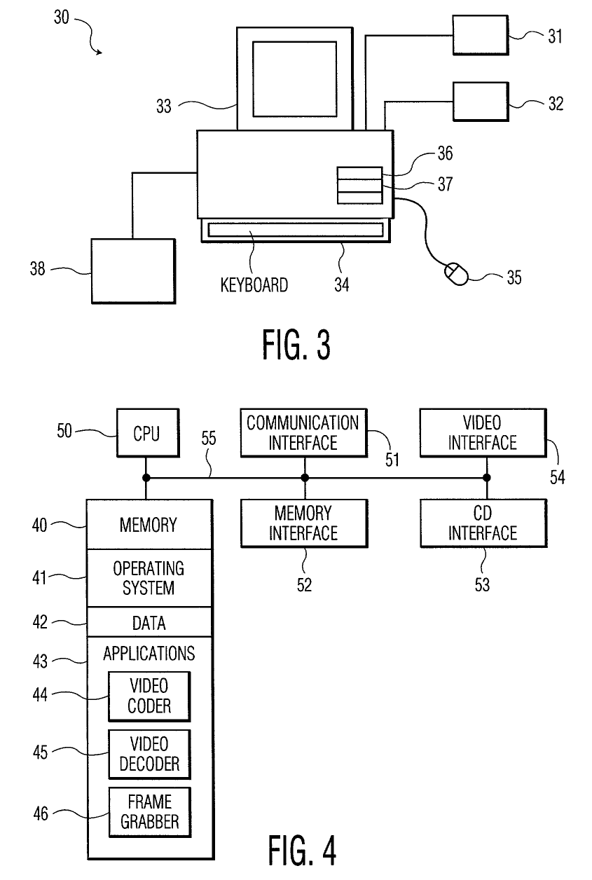

In a preferred embodiment, the functions of the system 1 are implemented by computer readable code executed by a data processing apparatus. The code may be stored in a memory within the data processing apparatus or read/downloaded from a memory medium such as a CD-ROM or floppy disk. In other embodiments, hardware circuitry may be used in place of, or in combination with, software instructions to implement the invention. These functions/software/hardware may be formed as part of the display device 11 or be an adjunct unit. The invention, for example, can also be implemented on a computer 30 shown in FIG. 3.

The computer 30 may include a network connection 31 for interfacing to a data network, such as a variable-bandwidth network or the Internet, and a fax/modem connection 32 for interfacing with other remote sources such as a video or a digital camera (not shown). The computer 30 may also include a display for displaying information (including video data) to a user, a keyboard for inputting text and user commands, a mouse for positioning a cursor on the display and for inputting user commands, a disk drive for reading from and writing to floppy disks installed therein, and a CD-ROM drive for accessing information stored on CD-ROM. The computer 30 may also have one or more peripheral devices 38 attached thereto inputting images, or the like, and a printer for outputting images, text, or the like.

The supplemental multimedia information 13 may also be provided to the computer via a memory storage device, e.g., a DVD. In this embodiment, the memory storage device contains the same information as the remote device 19, but is available locally.

FIG. 4 shows the internal structure of the computer 30 which includes a memory 40 that may include a Random Access Memory (RAM), Read-Only Memory (ROM) and a computer-readable medium such as a hard disk. The items stored in the memory 40 include an operating system 41, data 42 and applications 43. The operating system 41 may be a windowing operating system, such as UNIX; although the invention may be used with other operating systems as well such as Microsoft Windows 95.

Among the applications that may be stored in memory 40 are a video coder 44, a video decoder 45 and a frame grabber 46. The video coder 44 encodes video data in a conventional manner, and the video decoder 45 decodes video data which has been coded in the conventional manner. The frame grabber 46 allows single frames from a video signal stream to be captured and processed using image recognition software.

Also included in the computer 30 are a central processing unit (CPU) 50, a communication interface 51, a memory interface 52, a CD-ROM drive interface 53, a video interface 54 and a bus 55. The CPU 50 comprises a microprocessor or the like for executing computer readable code, i.e., applications, such those noted above, out of the memory 50. Such applications may be stored in memory 40 (as noted above) or, alternatively, on a floppy disk in disk drive 36 or a CD-ROM in CD-ROM drive 37. The CPU 50 accesses the applications (or other data) stored on a floppy disk via the memory interface 52 and accesses the applications (or other data) stored on a CD-ROM via CD-ROM drive interface 53.

Input video data may be received through the video interface 54 or the communication interface 51. The input video data may be decoded by the video decoder 45. Output video data may be coded by the video coder 44 for transmission through the video interface 54 or the communication interface 51.

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

What is claimed is:

1. A method for providing supplemental multimedia information to a video program, said method comprising the steps of:
displaying the video program;
receiving synchronizing information from the video program;
receiving the supplemental multimedia information in accordance with the synchronizing information formatted as an Internet document; and
displaying the supplemental multimedia information as a virtual web page.

2. The method according to claim 1, wherein the synchronizing information comprises keyframe information from the video program.

3. The method according to claim 1, wherein the synchronizing information comprises time code information from the video program.

4. The method according to claim 1, wherein the synchronizing information comprises image triggers identified using image recognition.

5. The method according to claim 1, wherein the supplemental multimedia information is displayed in a pop-up window.

6. The method according to claim 1, wherein the Internet document comprises a SMIL document.

7. The method according to claim 1, further comprising the step of extracting the synchronizing information from the video program.

8. The method according to claim 1, wherein the video program is a television program.

9. The method according to claim 8, wherein the synchronizing information comprises a CC or EDS type code.

10. The method according to claim 9, further comprising the step of displaying an on screen message when the CC or EDS type code is received.

11. The method according to claim 1, further comprising the step of providing a visual indication that the supplemental multimedia information is available before displaying the supplemental multimedia information.

12. An apparatus for displaying a video program comprising,
a display;
a controller arranged to display the video program using the display;
an interface for receiving supplemental information comprising an Internet document for the video program;
wherein the controller is also arranged to receive synchronization information from the video program, synchronize the supplemental information to the video program and display the supplemental information using the display as a virtual web page.

13. The apparatus according to claim 12, wherein the synchronizing information comprises keyframe information from the video program.

14. The apparatus according to claim 12, wherein the synchronizing information comprises time code information from the video program.

15. The apparatus according to claim 12, wherein the synchronizing information comprises image triggers identified using image recognition.

16. The apparatus according to claim 12, wherein the Internet document comprises a SMIL document.

17. The apparatus according to claim 12, wherein the video program is a television program and the synchronizing information comprises a CC or EDS type code.

18. An apparatus comprising:
a television receiver arranged to receive a television program signal;
an Internet enabled device arranged to received supplemental information comprising an Internet document;
means for synchronizing the supplemental information to the video program; and
means for displaying the television program signal and the supplemental information as a virtual web page.

19. The apparatus according to claim 18, further comprising means for extracting synchronization information from the television program signal.
